(19) United States
(12) Patent Application Publication
(10) Pub. No.: US 2022/0321306 A1
(43) Pub. Date: Oct. 6, 2022

(54) REPORT OF HARQ FEEDBACK IN SIDELINK TRANSMISSION

(71) Applicant: NEC Corporation, Minato-ku, Tokyo (JP)

(72) Inventor: Gang WANG, Beijing (CN)

(73) Assignee: NEC Corporation, Minato-ku, Tokyo (JP)

(21) Appl. No.: 17/619,767

(22) PCT Filed: Jun. 20, 2019
(86) PCT No.: PCT/CN2019/092020

§ 371 Date: Dec. 16, 2021

(51) Int. Cl. H04L 5/00; H04L 1/18

(52) U.S. Cl. CPC H04L 5/0055; H04L 1/1812

(57) ABSTRACT

Embodiments of the present disclosure relate to methods, devices and computer readable media for reporting a HARQ feedback in a sidelink transmission. A method performed by a terminal device includes: receiving, from a network device, one or more parameters related with reporting a hybrid automatic repeat request (HARQ) feedback in an uplink transmission for a sidelink transmission performed by the terminal device; and determining whether or not to report the HARQ feedback to the network device based on the one or more parameters.

### TECHNICAL FIELD

Embodiments of the present disclosure generally relate to the field of telecommunication, and in particular, to methods, devices and computer storage media for reporting a hybrid automatic repeat request (HARQ) feedback in a sidelink (SL) transmission.

### BACKGROUND

Device to device (D2D)/vehicle to everything (V2X) communications are enabled in 5G New Radio (NR). A sidelink transmission via a physical sidelink control channel (PSCCH) and a physical sidelink share channel (PSSCH) have been studied to enable communication between terminal devices. In the latest development, a physical sidelink feedback channel (PSFCH) is defined to convey sidelink feedback control information (SFCI) for unicast and groupcast. For a HARQ-based sidelink transmission, how to report the associated HARQ feedback to a network device for further allocation of resources for retransmission is highly concerned.

### SUMMARY

In general, embodiments of the present disclosure provide methods, devices and computer storage media for reporting a HARQ feedback in a sidelink transmission.

In a first aspect, there is provided a method of communication. The method comprises: transmitting, from a network device to a transmitting device in a sidelink transmission scheduled by the network device, an indication of reporting a HARQ feedback associated with the sidelink transmission; and receiving, from the transmitting device, the HARQ feedback associated with the sidelink transmission.

In a second aspect, there is provided a method of communication. The method comprises: receiving, by a transmitting device in a sidelink transmission from a network device, an indication of reporting a HARQ feedback associated with the sidelink transmission; and transmitting, to the network device, the HARQ feedback associated with the sidelink transmission.

In a third aspect, there is provided a network device. The network device comprises a processor and a memory coupled to the processor. The memory stores instructions that when executed by the processor, cause the network device to perform the method according to the first aspect of the present disclosure.

In a fourth aspect, there is provided a transmitting device in a sidelink transmission. The transmitting device comprises a processor and a memory coupled to the processor. The memory stores instructions that when executed by the processor, cause the transmitting device to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process for reporting a HARQ feedback associated with a sidelink transmission according to embodiments of the present disclosure;

FIG. 3 illustrates an example method of communication implemented at a network device in accordance with some embodiments of the present disclosure;

FIG. 4 illustrates an example method of communication implemented at a transmitting device in a sidelink transmission in accordance with some embodiments of the present disclosure;

FIG. 5 illustrates a schematic diagram of determining a slot for reporting a HARQ feedback associated with a sidelink transmission in accordance with some embodiments of the present disclosure; and

FIG. 6 is a simplified block diagram of a device that is suitable for implementing embodiments of the present disclosure.

Throughout the drawings; the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, a user equipment (UE), a mobile phone, a computer, a personal digital assistant, a game machine, a wearable device, an on-vehicle communication device, a machine type communication (MTC) device, a device to device (D2D) communication device, a vehicle to everything (V2X) communication device, a sensor and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best, lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

For a HARQ-based sidelink transmission, the reporting of a HARQ feedback associated with the sidelink transmission to a network device is not supported in existing solutions. For the purpose of requesting resources for HARQ based retransmission, it is agreed that the HARQ feedback associated with the sidelink transmission needs to be reported to the network device. Accordingly, how to report the HARQ feedback associated with the sidelink transmission to the network device for further allocation of resources for retransmission is highly concerned.

In view of this, embodiments of the present disclosure provide a solution for reporting a HARQ feedback associated with a sidelink transmission, so as to solve the above problems and one or more of other potential problems. The solution can achieve the reporting of the HARQ feedback by scheduling the sidelink transmission and thus facilitate a resource allocation for a HARQ based retransmission in the sidelink. Principles and implementations of the present disclosure will be described in detail below with reference to the figures.

FIG. 1 illustrates a schematic diagram of an example communication system 100 in which embodiments of the present disclosure can be implemented. As shown in FIG. 1, the communication system 100 may include a network device 110 and terminal devices 120 and 130 served by the network device 110. It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

As shown in FIG. 1, the network device 110 may communicate with the terminal devices 120 and 130 via channels (such as, wireless communication channels) 111 and 121, respectively. For example, the network device 110 may transmit a configuration about SFCI to the terminal devices 120 and 130 via the channels 111 and 121, respectively. During a sidelink transmission, the terminal devices 120 and 130, if acting as a receiving device, may transmit a HARQ feedback for PSSCH/PSCCH to a transmitting device based on the received configuration.

The terminal devices 120 and 130 are shown in FIG. 1 as vehicles which enable D2D/V2X communications. It is to be understood that embodiments of the present disclosure are also applicable to other terminal devices than vehicles, such as mobile phones, sensors and so on. In some embodiments, the terminal device 120 may communicate with the terminal device 130 via a sidelink 131. For example, the terminal device 120 may transmit information to the terminal device 130 via a PSSCH/PSCCH in the sidelink 131 and receive a HARQ feedback for reception of the information from the terminal device 130 via a PSFCH in the sidelink 131.

In the following, some embodiments will be described with reference to the terminal device 120 as an example of a transmitting device (also referred as a source device) and with reference to the terminal device 130 as an example of a receiving device (also referred as a destination device). For example, the terminal device 120 may also be referred to as the “transmitting device 120”, and the terminal device 130 may also be referred to as the “receiving device 130”. It is to be understood that this is merely for the purpose of discussion, without suggesting any limitations to the scope of the present disclosure.

The communications in the communication system 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G) 4.5G, the fifth generation (5G) communication protocols.

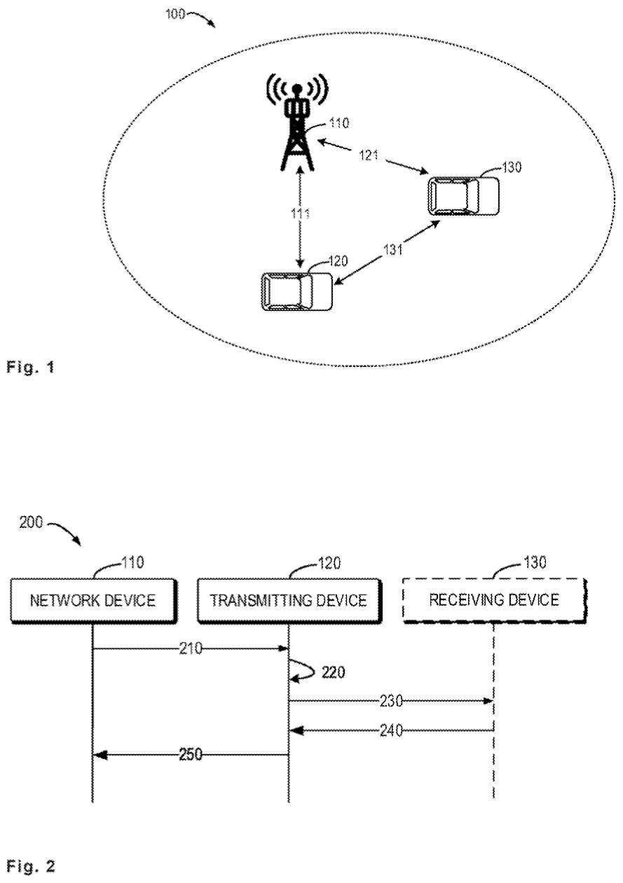

FIG. 2 shows a schematic diagram illustrating a process 200 for reporting a HARQ feedback associated with a sidelink transmission according to embodiments of the present disclosure. For the purpose of discussion, the process 200 will be described with reference to FIG. 1. The process 200 may involve the network device 110 and the terminal devices 120 and 130 as illustrated in FIG. 1.

As shown in FIG. 2, the network device 110 may transmit 210, to the transmitting device 120, an indication of reporting a HARQ feedback associated with a sidelink transmission between the transmitting device 120 and the receiving device 130. In some embodiments, the indication may specify whether the HARQ feedback is reported. Alternatively or additionally, in some embodiments, the indication may specify how to report the HARQ feedback. In some embodiments, the indication may specify how to perform the sidelink transmission.

For example, in some embodiments, the network device 110 may transmit, to the transmitting device 120, a sidelink grant on a downlink (DU) carrier to schedule a sidelink transmission. With the sidelink grant, the network device 110 may assign, to the transmitting device 120, a resource for the sidelink transmission, and transmit the indication so as to configure the transmitting device 120 to report the HARQ feedback associated with the sidelink transmission. In some alternative embodiments, the indication may be transmitted separately with the sidelink grant.

Upon receiving the indication, the transmitting device 120 may determine 220, based on the received indication, whether the HARQ feedback associated with the sidelink transmission is reported. Alternatively or additionally, in some embodiments, the transmitting device 120 may determine, based on the received indication, how to report the HARQ feedback. In some embodiments, the transmitting device 120 may determine, based on the received indication, how to perform the sidelink transmission.

The transmitting device 120 may transmit 230 traffic information via the sidelink 131 to the receiving device 130 based on the received indication. Upon receiving the traffic information, the receiving device 130 may transmit 240, to the transmitting device 120, the HARQ feedback such as an acknowledge (ACK) or a negative acknowledge (NACK) for the reception of the traffic information. Upon receiving the HARQ feedback from the receiving device 130, the transmitting device 120 may report 250 the HARQ feedback on an uplink (UL) carrier to the network device 110 based on the received indication. In this way, the network device 110 may correctly and timely perform the resource allocation for the HARQ based retransmission.

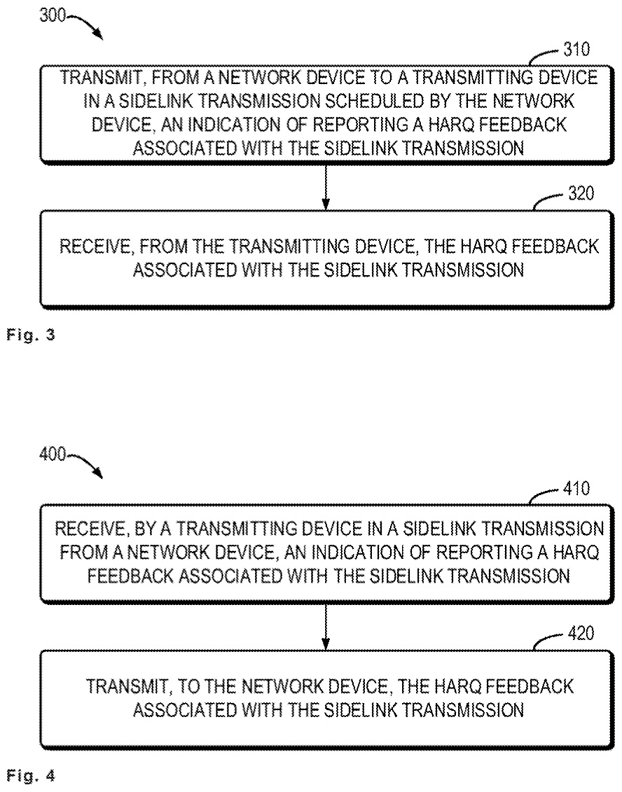

Embodiments of the present disclosure mainly involve an improvement for the communications at the network device 110 and at the transmitting device, and the communication at the receiving device 130 is not limited here, as shown by a dash line in FIG. 2. Corresponding to the process described in FIG. 2, embodiments of the present disclosure provide methods of communication implemented at a network device and a transmitting device in a sidelink scheduled by the network device. These methods will be described below with reference to FIGS. 3 and 4,

FIG. 3 illustrates an example method 300 of communication implemented at a network device in accordance with some embodiments of the present disclosure. For example, the method 300 may be performed at a communication device which acts as a network device, such as the network device 110. For the purpose of discussion, in the following, the method 300 will be described with reference to FIG. 1, It is to be understood that the method 300 may include additional blocks not shown and/or may omit some blocks as shown, and the scope of the present disclosure is not limited in this regard.

At block 310, the network device 110 transmit, to the transmitting device 120, an indication of reporting a HARQ feedback associated with a sidelink transmission between the transmitting device 120 and the receiving device 130. The processing may correspond to that at 210 in FIG. 2.

According to some embodiments of the present disclosure, the network device 110 may transmit a configuration parameter about the indication via a radio resource control (RRC) signaling. In some embodiments, the network device 110 may transmit one or more configuration parameters indicating at least one of: whether the reporting of the HARQ feedback is enabled; a priority of a transport block allowed to be transmitted by the transmitting device within the sidelink transmission, and whether the reporting of the HARQ feedback is enabled for a resource pool in which the sidelink transmission is performed.

For Type 1 configured sidelink grant, in some embodiments, the network device 110 may configure a first configuration parameter indicating whether the reporting of the HARQ feedback is enabled. In some embodiments, the network device 110 may configure a second configuration parameter indicating a priority of a TB allowed to be transmitted by the transmitting device 120 within the sidelink transmission. In some embodiments, the network device 110 may configure both the first and second configuration parameters.

Alternatively or additionally, according to some embodiments of the present disclosure, the network device 110 may incorporate the indication in downlink control information (DCI), and transmit the DCI to the transmitting device 120, for example, via a physical layer (Layer 1).

In some embodiments, the network device 110 may scramble a cyclic redundancy check (CRC) of the DCI by a radio network temporary identity (RNTI) indicating whether the reporting of the HARQ feedback is enabled. In this way, the reporting of the HARQ feedback can be implicitly indicated. In some embodiments, the RNTI may be a destination index corresponding to unicast or groupcast. In some embodiments, the RNTI may be configured by the network device 110 for unicast or groupcast. In some embodiments, the RNTI may be configured by the network device 110 for unicast or groupcast having a priority higher than a threshold. In some embodiments, the threshold may be configured by a higher layer signaling. In some embodiments, the threshold may be pre-configured by a device manufacturer. In some embodiments, the threshold may be predetermined.

In some embodiments, the network device 110 may add, in the DCI, one or more fields indicating whether the reporting of the HARQ feedback is enabled. Thereby, the reporting of the HARQ feedback can be explicitly indicated. In some embodiments, the one or more fields may comprise at least one of: a destination index for the sidelink transmission; a logic channel group allowed to be transmitted within the sidelink transmission; a priority of a transport block (TB) allowed to be transmitted within the sidelink transmission; and an uplink resource for the reporting of the HARQ feedback.

In some further embodiments, the network device 110 may add a field indicating the uplink resource for the reporting of the HARQ feedback by adding, in the field, an interval between an uplink slot for the reporting of the HARQ feedback and an uplink slot corresponding to the last symbol of a physical channel associated with the reporting of the HARQ feedback. In some embodiments, the physical channel may be selected from at least one of a PSFCH conveying the HARQ feedback for the sidelink transmission, a PDCCH conveying the DCI scheduling the sidelink transmission, and a PSSCH for the sidelink transmission. In this way, a slot for reporting the HARQ feedback can be determined appropriately and the HARQ feedback can be received correctly in the slot.

At block 320, the network device 110 receives, from the transmitting device 120, the HARQ feedback associated with the sidelink transmission. The processing may correspond to that at 250 in FIG. 2. In some embodiments, the network device 110 may perform a resource allocation for HARQ based retransmission in response to receiving a NACK associated with the sidelink transmission.

With the method 300, the understanding on reporting a HARQ feedback associated with a sidelink transmission scheduled by a network device can be aligned between the network device and a transmitting device in the sidelink transmission.

FIG. 4 illustrates an example method 400 of communication implemented at a transmitting device in a sidelink transmission in accordance with some embodiments of the present disclosure. For example, the method 400 may be performed at a communication device which acts as a transmitting device in a sidelink transmission, such as the transmitting device 120. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

At block 410, the transmitting device 120 receives, from the network device 110, an indication of reporting a HARQ feedback associated with the sidelink transmission. The processing may correspond to that at 220 in FIG. 2.

According to some embodiments of the present disclosure, the transmitting device 120 may receive one or more configuration parameters about the indication via a RRC signaling, and determine whether the reporting of the HARQ feedback is enabled based on the one or more configuration parameters.

In some embodiments, the transmitting device 120 may receive a first configuration parameter indicating whether the reporting of the HARQ feedback is enabled, and determine whether the reporting of the HARQ feedback is enabled based on the first configuration parameter. For Type 1 configured sidelink grant, in some embodiments, if the first configuration parameter indicates that the reporting is enabled, the transmitting device 120 may determine reporting the HARQ feedback to the network device 110 and may only transmit a unicast or groupcast TB with a priority higher than a specific threshold. In some embodiments, the specific threshold may be configured by a higher layer signaling. In some embodiments, the specific threshold may be pre-configured by a device manufacturer. In some embodiments, the specific threshold may be predetermined.

For Type 1 configured sidelink grant, in some embodiments, the transmitting device 120 may determine a second configuration parameter indicating a priority of a TB allowed to be transmitted by the transmitting device 120 within the sidelink transmission, and determine that the reporting of the HARQ feedback is enabled in response to the priority indicated by the second configuration parameter being higher than a first threshold. The determination of the first threshold is similar with that of the specific threshold described above, and its description is not repeated here. In this case, the transmitting device 120 may transmit, in the sidelink transmission, at least one TB having a priority higher than the priority indicated by the second configuration parameter. For example, the transmitting device 120 may only transmit a unicast and/or groupcast TB having a priority higher than the priority indicated by the second configuration parameter. As such, an overhead for HARQ feedback on the sidelink can be reduced.

In some embodiments, the transmitting device 120 may receive both the first and second configuration parameters. In this case, the transmitting device 120 may determine reporting the HARQ feedback to the network device 110 in response to the first configuration parameter indicating that the reporting is enabled, and may only transmit at least one TB having a priority higher than the priority indicated by the second configuration parameter, for example, a unicast and/or groupcast TB having a priority higher than the priority indicated by the second configuration parameter. As such, an overhead for HARQ feedback on the sidelink can be reduced.

In some alternative embodiments, the transmitting device 120 may receive a third configuration parameter indicating whether the reporting of HARQ feedback is enabled for a resource pool in which the sidelink transmission is performed, and determine whether the reporting of HARQ feedback is enabled based on the third configuration parameter. In some embodiments, the resource pool may be configured for at least one of unicast and groupcast. In some embodiments, if the third configuration parameter indicating that the reporting of HARQ feedback is enabled for the resource pool, the transmitting device 120 may determine that the reporting of HARQ feedback is enabled. In some embodiments, if the third configuration parameter indicating that the reporting of HARQ feedback is disabled for the resource pool, the transmitting device 120 may determine that the reporting of HARQ feedback is disabled

According to some embodiments of the present disclosure, the transmitting device 120 may receive DCI from the network device 110, and determine the indication incorporated in the DCI. In some embodiments, the transmitting device 120 may de-scramble a CRC of the DCI by a RNTI, and determine whether the reporting of the HARQ feedback is enabled based on the RNTI de-scrambling the CRC. In some embodiments, the RNTI may be a destination index corresponding to unicast or groupcast. In some embodiments, the RNTI may be configured by the network device 110 for unicast or groupcast. In some embodiments, the RNTI may be configured by the network device 110 for unicast or groupcast having a priority higher than a threshold. As such, an overhead for HARQ feedback on the sidelink can be reduced. In some embodiments, the threshold may be configured by a higher layer signaling. In some embodiments, the threshold may be pre-configured. In some embodiments, the threshold may be specified.

In some embodiments, the transmitting device 120 may determine, from the DCI, a field indicating whether the reporting of HARQ feedback is enabled for the sidelink transmission, and determine whether the reporting of the HARQ feedback is enabled based on the field. In some embodiments, the field may include a UL resource indicator. If the UL resource indicator is mapped to an invalid value, the transmitting device 120 may determine that the reporting is disabled. If the UL resource indicator is mapped to a valid value, the transmitting device 120 may determine that the reporting is enabled. In some embodiments, the UL resource indicator may be a time domain UL resource indicator for the reporting of HARQ feedback. In some embodiments, the UL resource indicator may be a frequency domain UL resource indicator for the reporting of HARQ feedback. In some embodiments, the UL resource indicator may be a spatial domain UL resource indicator for the reporting of HARQ feedback. An example of a time domain resource indicator is illustrated in Tables 1 and 2 described later.

In some further embodiments, the transmitting device 120 may transmit at least one logic channel having a priority higher than a first specific threshold. In some embodiments, the transmitting device 120 may transmit at least one TB having a priority higher than a second specific threshold. As such, an overhead on the sidelink can be reduced. The determination of the first and second specific thresholds is similar with that of the specific threshold described above, and its description is not repeated here.

In some alternative embodiments, the transmitting device 120 may determine, from the DCI, a first field indicating a destination index for the scheduled sidelink transmission, and determine whether the reporting of the HARQ feedback is enabled based on the destination index. In some embodiments, the transmitting device 120 may determine that the reporting of the HARQ feedback is enabled in response to the destination index corresponding to a traffic type for which the reporting of the HARQ feedback is enabled by a higher layer signaling. In some embodiments, if the destination index corresponds to a unicast or groupcast for which the reporting of the HARQ feedback is enabled by a higher layer signaling, the transmitting device 120 may determine that the reporting of the HARQ feedback is enabled. In some embodiments, if the destination index corresponds to a broadcast for which the reporting of the HARQ feedback is disabled by a higher layer signaling, the transmitting device 120 may determine that the reporting of the HARQ feedback is disabled. In some embodiments, the destination index at least may represent a destination identification (ID) and carrier information.

In some embodiments, the transmitting device 120 may determine, from the DCI, a first field indicating a destination index for the scheduled sidelink transmission, and a second field indicating a logic channel group allowed to be transmitted within the sidelink transmission by the transmitting device 120, and determine that the reporting of the HARQ feedback is enabled in response to the destination index corresponding to a traffic type for which the reporting of the HARQ feedback is enabled by a higher layer signaling, and a priority of the indicated logic channel group being higher than a second threshold. The determination of the second threshold is similar with that of the specific threshold described above, and its description is not repeated here. In this case, the transmitting device 120 may transmit at least one logic channel having a priority higher than that of the indicated logic channel group. As such, an overhead for HARQ feedback on the sidelink can be reduced.

In some embodiments, the transmitting device 120 may determine, from the DCI, a first field indicating a destination index for the scheduled sidelink transmission, and a third field indicating a priority of a TB allowed to be transmitted within the sidelink transmission by the transmitting device 120, and determine that the reporting of the HARQ feedback is enabled in response to the destination index corresponding to a traffic type for which the reporting of the HARQ feedback is enabled by a higher layer signaling, and the priority indicated in the third field being higher than a third threshold. The determination of the third threshold is similar with that of the specific threshold described above, and its description is not repeated here. In this case, the transmitting device 120 may transmit at least one TB having a priority higher than the priority indicated in the third field. As such, an overhead on the sidelink can be reduced.

In some embodiments, the transmitting device 120 may determine, from the DCI, a fourth field indicating an uplink resource for the reporting of HARQ feedback, and determine whether the reporting of the HARQ feedback is enabled based on the indicated uplink resource. In some embodiments, the uplink resource may be a time domain resource. In some embodiments, the uplink resource may be a frequency domain resource. In some embodiments, the uplink resource may be a spatial domain resource.

In some embodiments, if the fourth field indicates a valid value, the transmitting device 120 may determine the reporting of the HARQ feedback is enabled. If the fourth field indicates an invalid value, the transmitting device 120 may determine the reporting of the HARQ feedback is disabled.

In some embodiments, the transmitting device 120 may determine, in the fourth field, an interval between an uplink slot for the reporting of the HARQ feedback and an uplink slot corresponding to the last symbol in a physical channel (also referred as a reference channel) associated with the reporting of the HARQ feedback, determine the uplink slot for the reporting based on the fourth field and the last symbol in the physical channel associated with the reporting, and transmit the HARQ feedback in the determined uplink slot. In some embodiments, the physical channel may be selected from at least one of a PSFCH conveying the HARQ feedback for the sidelink transmission, a PDCCH conveying the DCI that schedules the sidelink transmission, and a PSSCH for the sidelink transmission.

In some example embodiments, the fourth field may include a time domain resource indicator, and the time domain resource indicator may be mapped to a value in a set S_UL of number of UI, slots, as shown in Table 1 and 2. The number of UL slots in S_UL means the interval described above. In some embodiments, S_UL may be configured by higher layer signaling. In some embodiments, S_UL or the values included in S_UL may be specific to a sub-carrier spacing (SCS) in a sidelink. It should be noted that the contents shown in Tables 1 and 2 are merely for illustration, and do not limit the present disclosure.

TABLE 1
an example mapping between a time domain resource
indicator and a value in the set S_UL

| Time domain resource indicator | Number of slots in the set S_UL |
|---|---|
| ‘000’ | 1^{st} value in the set S_UL |
| ‘001’ | 2^{nd} value in the set S_UL |
| ‘010’ | 3^{rd} value in the set S_UL |
| ‘011’ | 4^{th} value in the set S_UL |
| ‘100’ | 5^{th} value in the set S_UL |
| ‘101’ | 6^{th} value in the set S_UL |
| ‘110’ | 7^{th} value in the set S_UL |
| ‘111’ | 8^{th} value in the set S_UL |

TABLE 2
an example for the set S_UL

| 1^{st} | 2^{nd} | 3^{rd} | 4^{th} | 5^{th} | 6^{th} | 7^{th} | 8^{th} |
|---|---|---|---|---|---|---|---|
| a0 | a1 | a2 | a3 | a4 | a5 | a6 | a7 |

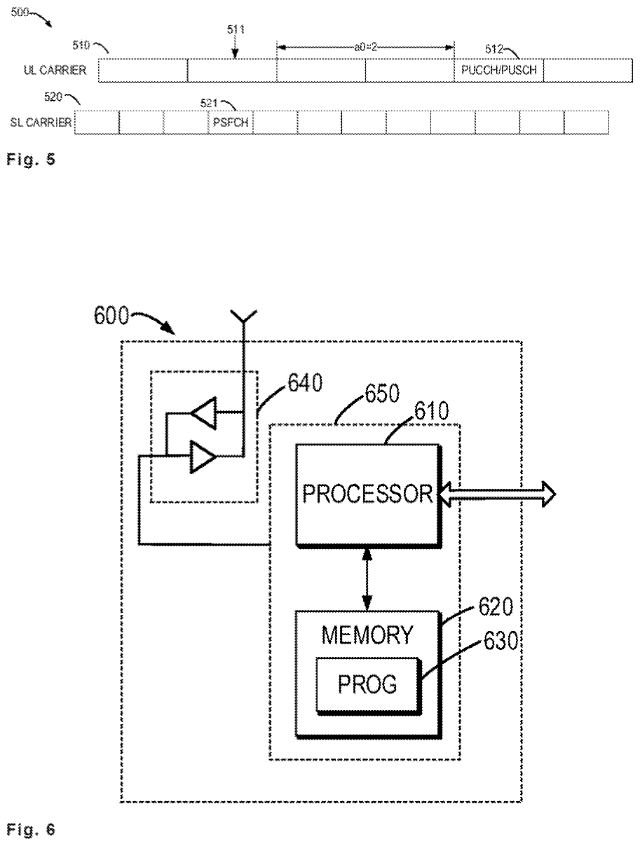

FIG. 5 illustrates a schematic diagram 500 of determining a slot for reporting a HARQ feedback associated with a sidelink transmission in accordance with some embodiments of the present disclosure. By way of an example, the PSFCH conveying the HARQ feedback for the sidelink transmission is selected as the reference channel.

As shown in FIG. 5, a PSFCH 521 in a SL carrier 520 is selected as the reference channel. With alignment between a UL carrier 510 and the SL carrier 520 in a time domain, a UL slot 511 in a UL carrier 510 corresponding to the last symbol of PSFCH 521 may be determined. Assuming that the time domain resource indicator in the fourth field indicates ‘000’, the time domain resource indicator is mapped to a value a0. Assuming a0=2, the UL slot 512 for reporting the HARQ feedback via a PUCCH/PUSCH may be determined. It should be noted that the contents shown in FIG. 5 are merely for illustration, and do not limit the present disclosure.

Based on the received indication, the transmitting device 120 transmits information of a sidelink transmission to the receiving device 130. With reference back to FIG. 4, at block 420, upon receiving a HARQ feedback associated with the sidelink transmission from the receiving device 130, the transmitting device 120 transmits, to the network device 110, the HARQ feedback associated with the sidelink transmission. In some embodiments, the transmitting device 120 may determine an uplink slot for the reporting based on the fourth field and the last symbol in a physical channel associated with the reporting, and transmit the HARQ feedback in the determined uplink slot.

With the method 400, the understanding on reporting a HARQ feedback associated with a sidelink transmission scheduled by a network device can be aligned between the network device and a transmitting device in the sidelink transmission, and the HARQ feedback can be reported appropriately and determined correctly.

FIG. 6 is a simplified block diagram of a device 600 that is suitable for implementing embodiments of the present disclosure. The device 600 can be considered as a further example implementation of the network device 110 or the terminal device 120 as shown in FIG. 1. Accordingly, the device 600 can be implemented at or as at least a part of the network device 110 or the terminal device 120.

As shown, the device 600 includes a processor 610, a memory 620 coupled to the processor 610, a suitable transmitter (TX) and receiver (RX) 640 coupled to the processor 1210, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Vu interface for communication between the eNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1.-27. (canceled)

28. A method performed by a terminal device, comprising:
receiving, from a network device, one or more parameters related with reporting a hybrid automatic repeat request (HARQ) feedback in an uplink transmission for a sidelink transmission performed by the terminal device; and
determining whether or not to report the HARQ feedback to the network device based on the one or more parameters.

29. The method of claim 28, wherein the one or more parameters indicate at least one of:
an uplink resource for the reporting of the HARQ feedback; and
an interval between a reception of a physical sidelink feedback channel (PSFCH) in response to the sidelink transmission and the uplink transmission for reporting the HARQ feedback.

30. The method of claim 29, wherein the interval indicates a number of slots.

31. The method of claim 28, wherein the one or more parameters are received via at least one of a radio resource control (RRC) signaling and downlink control information (DCI).

32. The method of claim 28 further comprising:
reporting the HARQ feedback to the network device based on the one or more parameters if the one or more parameters indicate the reporting of the HARQ feedback is enabled; and
determining not to report the HARQ feedback to the network device if the one or more parameters indicate the reporting of the HARQ feedback is disabled.

33. The method of claim 28 further comprising:
reporting the HARQ feedback in the uplink transmission in slot n+k, wherein a reception of a PSFCH for the sidelink transmission ends in a slot n, k indicates a number of slots between the reception of physical sidelink feedback channel (PSFCH) in response to the sidelink transmission and the uplink transmission for reporting the HARQ feedback.

34. The method of claim 28, wherein the uplink transmission comprises a PUCCH transmission or a PUSCH transmission.

35. A method performed by a network device, comprising:
transmitting, to a terminal device, one or more parameters related with reporting a hybrid automatic repeat request (HARQ) feedback in an uplink transmission for a sidelink transmission performed by the terminal device; and
receiving the reporting of the HARQ feedback from the terminal device.

36. The method of claim 35, wherein the one or more parameters indicate at least one of:
an uplink resource for the reporting of the HARQ feedback; and
an interval between a transmission of a physical sidelink feedback channel (PSFCH) in response to the sidelink transmission and the uplink transmission for reporting the HARQ feedback.

37. The method of claim 36, wherein the interval indicates a number of slots.

38. The method of claim 35, wherein the one or more parameters are received via at least one of a radio resource control (RRC) signaling and downlink control information (DCI).

39. The method of claim 35 further comprising:
receiving the reporting of the HARQ feedback from the terminal device if the one or more parameters indicate the reporting of the HARQ feedback is enabled.

40. The method of claim 35 further comprising:
receiving the reporting the HARQ feedback in the uplink transmission in slot n+k, wherein a transmission of a PSFCH for the sidelink transmission ends in a slot n, k indicates a number of slots between the transmission of physical sidelink feedback channel (PSFCH) in response to the sidelink transmission and the uplink transmission for reporting the HARQ feedback.

41. The method of claim 35, wherein the uplink transmission comprises a PUCCH transmission or a PUSCH transmission.

42. A terminal device comprising a processor configured to:
receive, from a network device, one or more parameters related with reporting a hybrid automatic repeat request (HARQ) feedback in an uplink transmission for a sidelink transmission performed by the terminal device; and
determine whether or not to report the HARQ feedback to the network device based on the one or more parameters.

43. The terminal device of claim 42, wherein the one or more parameters indicate at least one of:
an uplink resource for the reporting of the HARQ feedback; and
an interval between a reception of a physical sidelink feedback channel (PSFCH) in response to the sidelink transmission and the uplink transmission for reporting the HARQ feedback.

44. The terminal device of claim 42, wherein the processor is further configured to:
report the HARQ feedback in the uplink transmission in slot n+k, wherein a reception of a PSFCH for the sidelink transmission ends in a slot n, k indicates a number of slots between the reception of physical sidelink feedback channel (PSFCH) in response to the sidelink transmission and the uplink transmission for reporting the HARQ feedback.

45. A network device, comprising a processor configured to:
transmit, to a terminal device, one or more parameters related with reporting a hybrid automatic repeat request (HARQ) feedback in an uplink transmission for a sidelink transmission performed by the terminal device; and
receive the reporting of the HARQ feedback from the terminal device.

46. The network device of claim 45, wherein the one or more parameters indicate at least one of:
an uplink resource for the reporting of the HARQ feedback; and
a transmission of an interval between a physical sidelink feedback channel (PSFCH) in response to the sidelink transmission and the uplink transmission for reporting the HARQ feedback.

47. The network device of claim 45, wherein the processor is further configured to:
receive the reporting the HARQ feedback in the uplink transmission in slot n+k, wherein a transmission of a PSFCH for the sidelink transmission ends in a slot n, k indicates a number of slots between the transmission of physical sidelink feedback channel (PSFCH) in response to the sidelink transmission and the uplink transmission for reporting the HARQ feedback.
